(19) United States
(12) Patent Application Publication
(10) Pub. No.: US 2018/0125131 A1
(43) Pub. Date: May 10, 2018

(54) MANUFACTURING METHOD OF SILICONE-COATED GLOVE

(71) Applicant: HEUNGJE INTERNATIONAL CORP., Daegu (KR)

(72) Inventor: Hae Soo LEE, Daegu (KR)

(73) Assignee: HEUNGJE INTERNATIONAL CORP., Daegu (KR)

(21) Appl. No.: 15/571,469

(22) PCT Filed: Jul. 9, 2015
(86) PCT No.: PCT/KR2015/007157

§ 371 Date: Nov. 2, 2017

(51) Int. Cl. A41D 19/015; A41D 19/00; B29C 41/00; B29C 41/14; B29C 41/20

(52) U.S. Cl. CPC A41D 19/01529; A41D 19/0082; B29C 41/003; A41D 19/04; B29C 41/20; A41D 19/01558; B29C 41/14

(57) ABSTRACT

A manufacturing method of a silicone-coated glove, comprises: a knitting step (S100) of forming a glove; a water-repellency treatment solution preparation step (S200) of forming a water-repellency treatment solution by diluting a silicone-containing water-repellent agent for fabrics with water; a water-repellency treatment solution dipping step (S300) of dipping the knitted glove in the water-repellency treatment solution; a water-repellent coating formation step (S400) of forming, on a fabric layer (10) of the glove, a water-repellent coating (20) containing silicone by dehydrating the glove dipped in the water-repellency treatment solution and then drying the glove at 80-180° C.; a dipping step (S500) of forming a silicone coating (30) by dipping the glove having the water-repellent coating (20) in a silicone coating solution; and a drying step of hardening the glove having the silicone coating (30).

### BACKGROUND

The present invention relates to a manufacturing method of a silicone-coated glove, and more particularly, to a method for manufacturing a silicone-coated glove using silicone resin, which is harmless to the human body and has excellent cold-resistance and heat-resistance, thereby solving problems of working gloves or flame-resistant gloves used in pharmaceutical companies, cold storages or the like and improving the quality of the gloves.

In general, a coated glove is a glove of which the entire or a part is coated with natural resin or synthetic resin in order to improve workability by preventing sliding and preventing the glove from getting wet in liquid, such as water, oil or chemicals. Thus, various kinds of resins for coating may be used according to grip force, air-permeability, elasticity, wearing sensation, oil resistance, durability, or others required for coated gloves.

Conventionally, polyurethane-coated gloves have been mainly used. Such polyurethane-coated gloves have excellent grip force and durability and are cheap. In connection with the above,

Korean Patent No. 10-0429310 (published on May 3, 2004) discloses a coated glove manufacturing method and a coated glove manufactured thereby. According to Korean Patent No. 10-0429310, a glove is dipped into a coating agent, in which dimethylformamide (DMF), surfactant and pigment are mixed relative to polyurethane, so as to form a polyurethane-coated glove.

In this instance, dimethylformamide (DMF) mixed to the coating agent serves as a solvent to dilute polyurethane. According to a mixing ratio of DMF, the thickness of a resin film coated on the glove is determined. An appropriate amount of DMF makes resin coated on a glove moderately thin to improve wearing sensation and movement of the coated glove.

However, it has been known that advanced countries have classified DMF as a toxic substance limited in use because DMF may damage liver, cause a cancer, a skin disease, or various symptoms, such as languor, dizziness, a headache, a stomachache, nausea, vomit, constipation or others. For instance, according to the National Institute for Occupational Safety and Health's recommended exposure limit and Occupational Safety and Health Administration's permissible exposure limit in the United States, it has been provided that the average skin contact amount for 8 hours is 10 ppm.

Therefore, conventionally, a glove is dipped into polyurethane resin to form a coated glove, and then, the coated glove is washed by stages to elute DMF, which is a toxic substance, from the resin film of the coated glove. However, such a method cannot perfectly remove DMF, and an amount of DMF residues does not still satisfy the permissible exposure limit of the advanced countries.

For that reason, despite many advantages, such polyurethane-coated gloves have a disadvantage in that they are unsuitable for working gloves in pharmaceutical companies or food companies.

Moreover, in the case that the polyurethane-coated gloves are used as working gloves in cold storages, due to lack of cold resistance (−40° C.), the polyurethane-coated gloves have another disadvantage in that movement is deteriorated and durability is also deteriorated because the polyurethane coating is easily exfoliated from the glove.

Particularly, due to lack of thermal resistance (150° C.), in the case that the polyurethane-coated gloves are used as flame-resistant gloves, it may cause a serious problem. Generally, flame-resistant gloves are knitted with aramid fiber or Kevlar fiber, which has a high ignition point to provide an excellent flame-resistant effect. However, because the polyurethane resin coated on the flame-resistant glove is melted at about 150° C. and infiltrates into the flame-resistant glove, there is a risk of burns by skin contact, and finally, it may remarkably deteriorate the function of the flam-resistant glove.

In the meantime, in order to solve the problems of such polyurethane-coated gloves, a coated glove using silicone resin, which is harmless to the human body and has excellent cold resistance (−180° C.) and thermal resistance (700° C.), has been experimentally manufactured. However, coating films 120 and 130 are formed thick on the inner surface and the outer surface of a fiber layer 110 because the silicone resin easily infiltrates into the fiber layer 110 of the glove during a dipping step as shown in FIG. 1. Thus, such a silicone-coated glove has several problems in that wearing sensation and movement are bad, and in that its productivity is very bad and the silicone-coated glove failed in product commercialization because the silicone coating film 130 infiltrating into the glove is bonded to a mold (M) and the coated glove 100 cannot be easily separated from the mold (M).

Patent Document 1: Korean Patent No. 10-0429310 (published on May 3, 2004)

### SUMMARY OF THE INVENTION

Accordingly, the present invention has been made in view of the above-mentioned problems occurring in the conventional polyurethane-coated gloves and silicone-coated gloves, and it is an object of the present invention to provide a method for manufacturing a silicone-coated glove using silicone resin, which is harmless to the human body and has excellent cold-resistance and heat-resistance to prevent silicone coating solution from infiltrating into a fiber layer of a glove and make the coated glove easily separated from a mold after a dipping step, thereby providing good wearing sensation and movement, improving productivity, putting silicone-coated gloves to practical use, and facilitating commercialization.

To accomplish the above object, according to the present invention, there is provided a method for manufacturing a silicone-coated glove including: a knitting step of forming a glove; a water-repellency treatment solution preparation step of forming a water-repellency treatment solution by diluting a silicone-containing water-repellent agent for fiber with water; a water-repellency treatment solution dipping step of dipping the knitted glove in the water-repellency treatment solution; a water-repellent coating formation step of forming a silicone-containing water-repellent film on a fiber layer of the glove by dehydrating the glove dipped in the water-repellency treatment solution and drying the glove at 80° C. to 180° C.; a dipping step of forming a silicone film by dipping the glove having the water-repellent film in a silicone coating solution; and a drying step of hardening the glove having the silicone coating.

Moreover, the water-repellent agent for fiber in the water-repellency treatment solution preparation step is a water-soluble fluorinated water-repellent agent, and 20% to 40% by weight of silicone-based mixture is added to 60% to 80% by weight of the water-soluble fluorinated water-repellent agent in order so that silicone is contained in the water-repellent agent for fiber, and then, the water-repellent agent is diluted with water to be 3% to 10% of aqueous solution, such that a water-repellency treatment solution is formed.

Furthermore, the silicone coating solution in the dipping step is made in such a way that 0.5 to 5 parts by weight of a retarder is added with respect to 100 parts by weight of silicone-hardener mixture, in which 50% to 90% by weight of silicone base and 10% to 50% by weight of a hardener are mixed.

### Advantageous Effects

As described above, the method for manufacturing a silicone-coated glove according to the present invention can improve wearing sensation and movement of the silicone-coated glove because a water-repellent film is formed before a glove is dipped into a silicone coating solution and the silicone coating solution does not infiltrate into the glove. Additionally, because the water-repellent film has the same silicone-based mixture as the silicone coating solution, the silicone film formed on the surface of the glove is not easily exfoliated and has durability. Furthermore, because the silicone coating solution does not infiltrate into the glove, the glove can be easily separated from the mold after the dipping step.

Therefore, the method for manufacturing a silicone-coated glove using silicone resin, which is harmless to the human body and has excellent cold-resistance and heat-resistance facilitate practical use and commercialization of silicone-coated gloves, and provides silicone-coated gloves suitable for being used for work in pharmaceutical companies, cold storages or the like, and particularly suitable for use as fire-resistant gloves.

### BRIEF DESCRIPTION OF DRAWINGS

FIG. 1 is an enlarged sectional view of a silicone-coated glove manufactured by a general dipping step.

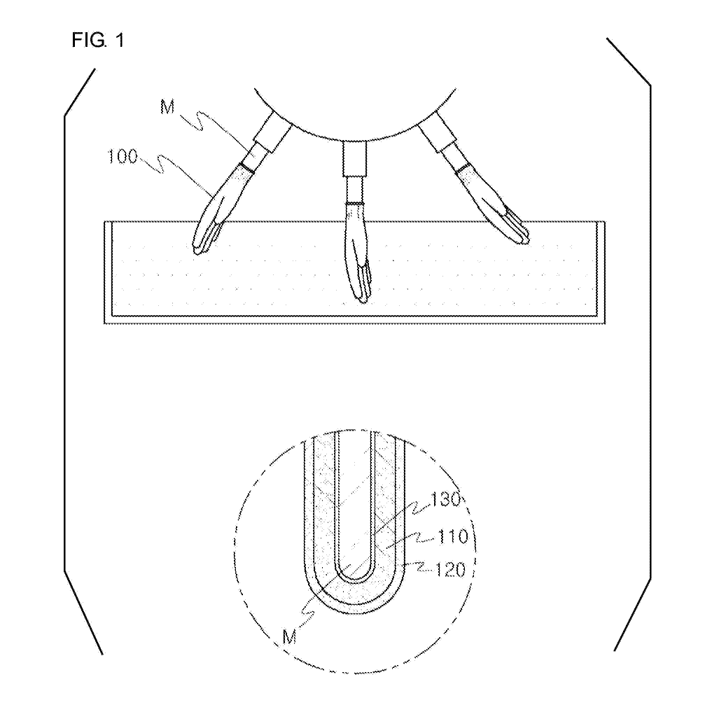

FIG. 2 is a flow chart showing a manufacturing method of a silicone-coated glove according to a preferred embodiment of the present invention.

FIG. 3 is a perspective view showing the silicone-coated glove according to the preferred embodiment of the present invention, and an enlarged sectional view of the silicone-coated glove.

### REFERENCE NUMERALS IN DRAWINGS

1: Coated glove 10: fiber layer

20: Water-repellent film 30: Silicone film

S100: Knitting step

S200: Water-repellency treatment solution preparation step

S300: Water-repellency treatment solution dipping step

S400: Water-repellent coating formation step

S500: Dipping step S600: Drying step

### DETAILED DESCRIPTION OF THE INVENTION

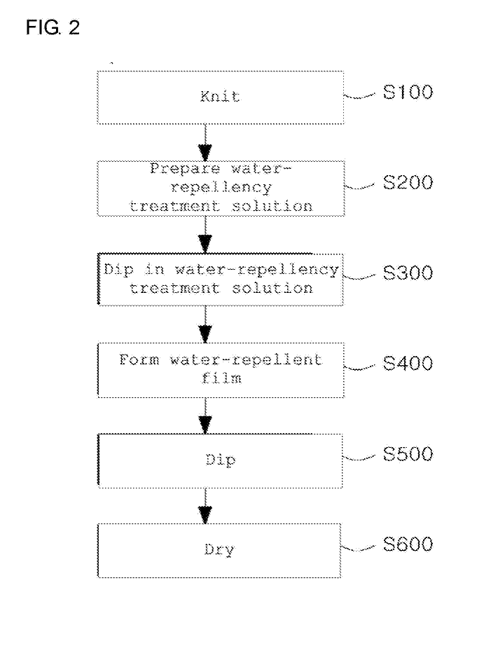

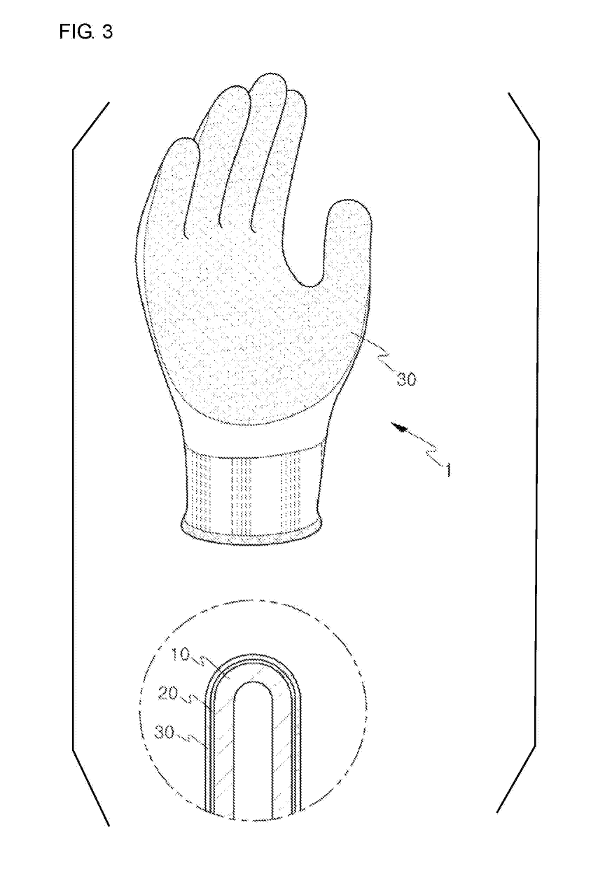

Referring to FIGS. 2 and 3, a manufacturing method of a silicone-coated glove according to a preferred embodiment of the present invention will be described, and in this instance, the manufacturing method will be described in detail by being divided into a knitting step, a water-repellency treatment solution preparation step, a water-repellency treatment solution dipping step, a water-repellent coating formation step, a dipping step, and a drying step.

1. Knitting step

A knitting step S100 is a step of forming a glove using a knitting machine. The glove may be formed using various kinds of natural fiber or synthetic fiber according to use purposes. In the case of a silicone-coated glove for industrial use or for insulation in pharmaceutical companies or food companies, the glove is knitted with nylon fiber. In the case of a coated glove used for a cold storage, the glove is knitted with Thermolite fiber. Moreover, in the case of a flame-resistant glove, preferable, the glove is knitted with aramid fiber or Kevlar fiber. However, in the present invention, the knitted glove is not limited to such fiber materials of the gloves.

2. Water-Repellency Treatment Solution Preparation Step

A water-repellency treatment solution preparation step S200 is a step of forming a water-repellency treatment solution by diluting water-repellent agent for silicone-containing fiber with water. In detail, the water-repellent agent for fiber is a water-soluble fluorinated water-repellent agent. When 20% to 40% by weight of silicone-based mixture is added to 60% to 80% by weight of the water-soluble fluorinated water-repellent agent, silicone is contained in the water-repellent agent for fiber. After that, the water-repellent agent for fiber, which contains silicon, is diluted with water to be 3% to 10% of aqueous solution, such that a water-repellency treatment solution is formed. In this instance, the water-soluble fluorinated water-repellent agent is circulating in the market, and is not limited to the kinds.

Furthermore, for the silicone-based mixture, various kinds of polymers according to polymerization methods have been known. So, the silicone-based mixture is not limited to kinds of silicone resins, for instance, made with polydimethylsioxane molecules or oligosiloxane molecules. The silicone-based mixture contained in the water-repellency treatment solution has the same material as a silicone film, which will be formed after the dipping step so as to improve durability, such that the silicone film is not easily exfoliated from the surface of the glove.

3. Water-Repellency Treatment Solution Dipping Step

A water-repellency treatment solution dipping step S300 is a step of dipping the knitted glove into the water-repellency treatment solution. Through the water-repellency treatment solution dipping step S300, the silicone-based mixture contained in the water-repellency treatment solution can be dispersed evenly onto the fiber layer 10 of the glove. In the meantime, this step may have the same effect as the case that a glove is dipped into the water-repellency treatment solution in a water tank and the case that the water-repellency treatment solution is sprayed onto the glove so that the glove is soaked with the water-repellency treatment solution.

### 4. Water-Repellent Coating Formation Step

A water-repellent coating formation step S400 is a step of forming a water-repellent film 20 by a fluorine ingredient contained in the water-repellency treatment solution by drying the glove dipped in the water-repellency treatment solution at high temperature. Preferably, the water-repellency treatment solution infiltrated in the glove is first dehydrated before the glove is dried at high temperature, and then, the glove is dried with hot air of 80° to 180°, such that the water-repellent film 20 is formed on the entire of the fiber layer 10 of the glove.

5. Dipping Step

A dipping step S500 is a step of forming a silicone film 30 on the entire or a part of the glove by dipping the glove having the water-repellent film 20 into a silicone coating solution. In this instance, the silicone coating solution does not excessively infiltrate into the glove but is coated on the glove with a moderate thickness due to the water-repellent film 20. On the other hand, because the water-repellent film 20 contains the silicone-based mixture, the silicone film 30 with the same ingredient as the water-repellent film 20 is not easily exfoliated from the surface of the glove.

Now, ingredients of the silicone coating solution will be described in detail. Preferably, the silicone coating solution includes 50% to 90% by weight of silicone base and 10% to 50% by weight of a hardener. Preferably, with respect to 100 parts by weight of silicone-hardener mixture, in which the silicone base and the hardener are mixed, 0.5 to 5 parts by weight of a retarder is added to prevent the silicone coating solution from being hardened during the dipping step.

Furthermore, an antifoaming agent for removing bubbles and a pigment for giving color may be selectively mixed to the silicone coating solution. In the case that the antifoaming agent or the pigment is mixed, it is preferable that 1 to 3 parts by weight of antifoaming agent or pigment is added with respect to 100 parts by weight of the silicone-hardener mixture.

6. Drying Step

A drying step S600 is a step of hardening the silicone film 30 formed on the glove. When hot air of 80° C. to 150° C. is applied to the glove having the silicone film 30, the silicone film 30 is hardened. In this instance, the retarder contained in the silicone film 30 is evaporated, such that hardening of the silicone film 30 is facilitated.

Hereinafter, the action of the present invention will be described. Before the dipping step S500 of the silicone coating solution, the water-repellent film 20 is formed on the entire of the fiber layer 10 of the glove by the water-repellent coating formation step S400. After that, in the dipping step S500, because the silicone coating solution does not infiltrate into the inside of the glove by the water-repellent film 20, the silicone-coated glove 1 according to the preferred embodiment of the present invention can form the silicone film 30 with a moderate thickness, thereby improving wearing sensation and movement.

In the meantime, if only the water-repellent film 20 is simply formed, the silicone film 30 may be easily exfoliated from the glove, but because the silicone-based mixture, which has the same ingredient as the silicone film 30, is added to the water-soluble fluorinated water-repellent agent in the water-repellency treatment solution preparation step S200 and the silicone-based mixture is evenly diffused to the entire of the fiber layer 10 of the glove in the water-repellency treatment solution dipping step S300, the silicone film 30 produced after the dipping step S500 and the drying step S600 is not easily exfoliated from the glove and maintains its durability.

Moreover, as described above, because the silicone coating solution does not infiltrate into the inside of the glove, the present invention does not cause the problem of the conventional arts that the infiltrated silicone resin is bonded to the mold and is not separated from the mold, and so, improves productivity of the silicone-coated glove 1 and facilitates mass production and commercialization of the silicone-coated glove 1.

Therefore, in order to solve the problems of the conventional polyurethane-coated glove, the present invention can manufacture the silicone-coated glove 1, which is harmless to the human body and has excellent cold-resistance and heat-resistance. Additionally, in order to solve the problems of the conventional silicone-coated glove, the present invention can manufacture the silicone-coated glove 1 with excellent wearing sensation, movement and durability. In addition, the present invention can manufacture silicone-coated gloves suitable for being used for work in pharmaceutical companies, cold storages or the like and particularly suitable for use as a fire-resistant glove, because putting the silicone-coated glove to practical use and facilitating commercialization of the silicone-coated glove 1 by improving productivity.

1. A manufacturing method of a silicone-coated glove comprising:
a knitting step (S100) of forming a glove;
a water-repellency treatment solution preparation step (S200) of forming a water-repellency treatment solution by diluting a silicone-containing water-repellent agent for fiber with water;
a water-repellency treatment solution dipping step (S300) of dipping the knitted glove in the water-repellency treatment solution;
a water-repellent coating formation step (S400) of forming a silicone-containing water-repellent film (20) on a fiber layer (10) of the glove by dehydrating the glove dipped in the water-repellency treatment solution and drying the glove at 80° C. to 180° C.;
a dipping step (S500) of forming a silicone film (30) by dipping the glove having the water-repellent film (20) in a silicone coating solution; and
a drying step of hardening the glove having the silicone coating (30).

2. The manufacturing method according to claim 1, wherein the water-repellent agent for fiber in the water-repellency treatment solution preparation step (S200) is a water-soluble fluorinated water-repellent agent, and 20% to 40% by weight of silicone-based mixture is added to 60% to 80% by weight of the water-soluble fluorinated water-repellent agent in order so that silicone is contained in the water-repellent agent for fiber, and then, the water-repellent agent is diluted with water to be 3% to 10% of aqueous solution, such that a water-repellency treatment solution is formed.

3. The manufacturing method according to claim 1, wherein the silicone coating solution in the dipping step (S500) is made in such a way that 0.5 to 5 parts by weight of a retarder is added with respect to 100 parts by weight of silicone-hardener mixture, in which 50% to 90% by weight of silicone base and 10% to 50% by weight of a hardener are mixed.
